(19) United States
(12) Patent Application Publication
(10) Pub. No.: US 2007/0209836 A1
(43) Pub. Date: Sep. 13, 2007

(54) Bushing

(75) Inventors: Asem Kaifie, Hamburg (DE); Helge Schwarz, Garlstorf (DE); Andre Schmidt, Buchholz (DE); Maximilian Jeglitzka, Stuttgart (DE)

Correspondence Address: HARNESS, DICKEY & PIERCE, P.L.C., P.O. BOX 828, BLOOMFIELD HILLS, MI, 48303, US

(73) Assignee: Carl Freudenberg KG, Weinheim (DE)

(21) Appl. No.: 11/656,559

(22) Filed: Jan. 22, 2007

(30) Foreign Application Priority Data
Sep. 7, 2005 (DE) 102005042612.3-12

(51) Int. Cl. H02G 3/18

(52) U.S. Cl. 174/659; 174/650

(57) ABSTRACT

A bushing comprising a core, at least one sleeve surrounding the bushing and at least one elastic layer disposed between the sleeve and the core. The elastic layer and the sleeve are interrupted by a gap, and the gap width is elastically changeable. The bushing may be adapted to different stress situations, and the bushing may characterized in that the ends of the elastic layer on the side of the gap are provided with recesses.

### CROSS-REFERENCE TO RELATED APPLICATIONS

This application is based on German Patent Application No. 10 2005 042 612.3-12, filed Sep. 7, 2005. The disclosure of the above application is incorporated herein by reference.

### FIELD

The present teachings relate to a bushing comprising a core, at least one sleeve surrounding the core and at least one elastic layer which is disposed between the sleeve and the core. The elastic layer and the sleeve are interrupted by a gap, and the width of the gap is elastically changeable.

### BACKGROUND

The statements in this section merely provide background information related to the present disclosure and may not constitute prior art.

Bushings find use in, among other fields, chassis of automotive vehicles. Because of the elastic layers that are connected with the core or the sleeve, radial stiffness and torsional stiffness are conferred to such bushings when the sleeve is moved relative to the core.

Bushings of this variety have a wedge-shaped gap that is made to close when, in one arrangement, the bushing is compressed. In a compressed condition, however, slit bushings of show only a direction-dependent radial stiffness. This restricts the application fields of the bushings markedly because they cannot withstand stressing in different radial space directions to a sufficient extent.

### SUMMARY

The present teachings provide a bushing that can readily be adapted to different stressing situations.

The present teachings provide a bushing that may be characterized in that the ends of the elastic layer on the side of the gap are provided with recesses.

The present teachings were developed in light of conventional bushings showing only radial stiffness that limits their use. To this end, the present teachings achieve radial stiffness by modifying the elastic layer. In this regard, providing recesses at the ends of the elastic layer on the side of the gap enables creation of an asymmetry of the elastic layer, which gives rise to two radial stiffnesses in different stressing directions. By presenting two radial stiffnesses, the slit bushing of the invention can be adapted to different stressing situations.

In an embodiment that is particularly advantageous from a constructive standpoint, the ends on the side of the gap of at least one sleeve may contact one another. This ensures that in the compressed state the sleeve will absorb radially acting compressive forces and place the elastic layer under a defined pretension which allows a defined adjustment of the radial stiffnesses.

The ends of the elastic layer on the side of the gap define a passage. This embodiment makes it possible to form a hollow space in the elastic layer, which results in an asymmetry in its structure. In other words, in the case of a round layer, this provides a region which is configured as a hollow space. The formation of the hollow space gives rise to a radial stiffness which is different in the direction of the hollow space compared to a radial stiffness perpendicular to this direction.

The recesses of the elastic layer may be concave. This allows the creation of, for example, a kidney-shaped, elliptical, or spherical hollow-space structure. As a result of this geometry, the radial stiffness in the direction of the hollow space is lower than in the direction perpendicular to it. The radial stiffness can be chosen depending on the selection of the geometry of the hollow space.

The recesses may, at least in some regions, be spherical in shape. The spherical shape makes it possible to create a symmetrical hollow space, namely one in which two semicircles form a full circle when the bushing is compressed and the ends of the elastic layer on the side of the gap contact one another. This geometry permits a simple and problem-free construction of the layer.

The hollow space may also be elliptical, at least in some regions. This permits an adjustment of radial stiffness by proper sizing of the half-axes of the ellipse formed.

It is also possible to provide in one layer several hollow spaces that are separated by partitioning walls, or can be separated by compressing the bushing. The hollow spaces may be disposed next to one another or over one another. Individual hollow spaces may also be enclosed in the layer in the form of bubbles or pores. In particular, several elastic layers can be disposed concentrically relative to one another and define superposed hollow spaces. As a result of these specific configurations, the radial stiffness can be adjusted by the selection of the number and arrangement of the hollow spaces. Moreover, a quasi serial or parallel connection of the spring elements can be achieved.

The radial stiffness along the central axis of the gap amounts to a maximum of 8000 N/mm. This value was found to be particularly advantageous when the bushing is used in chassis of automotive vehicles and is to provide good suspending characteristics. A particularly preferred radial stiffness along the central axis of the gap amounts to between 4000 and 8000 N/mm. This radial stiffness is advantageous when two elastic layers are disposed between an outer sleeve and an intermediate sleeve or the core.

The radial stiffness along the central axis of the gap amounts to 8000 N/mm at the most. This value was found to be particularly advantageous when the bushing is used in chassis of automotive vehicles and good suspension characteristics are to be achieved. Most advantageously, the radial stiffness along the central axis of the gap is between 4000 and 8000 N/mm. This radial stiffness is advantageous when two elastic layers are disposed between an outer and an inter-mediate sleeve or the core.

The radial stiffness perpendicular to the central gap axis is at most 12,000 N/mm. This radial stiffness was found to be particularly advantageous when the bushing is subjected to high radial stresses in automotive vehicles. When two elastic layers are used in a bushing, a stiffness of 8000 to 12,000 N/mm was found to be advantageous.

The aforementioned values alone or in combination were found to be particularly advantageous when a bushing is used in a torsion bar bearing of a front axle, a spring eye bearing of the rear axle, or a cross-brace bearing of a front axle. The bushing, however, may be disposed in any other functional position of the front and rear axles, as long as this makes sense in terms of the mechanical properties of the bushing.

At least one intermediate sleeve can be disposed between the core and the sleeve, with at least one elastic layer being disposed between the core and the intermediate sleeve and between the intermediate sleeve and the sleeve. This specific configuration allows a particularly stable bushing structure and the creation of several elastic regions that are separated from each other and in which hollow spaces are provided.

At least one elastic layer can be connected with the sleeves and/or the core by vulcanization. The elastic layer may be made of rubber. The connection of the elastic layer with the sleeves and/or the core by vulcanization ensures a durable and strong connection and problem-free force transmission in the event of torsional movements.

It is also possible to use an elastic layer made of rubber which is not connected to the sleeves and/or the core by vulcanization. For example, at least one layer made of rubber or some other suitable material may be provided by pressure fitting. In this embodiment, keeping in mind the material characteristics of the layer, the layer is not impaired by a vulcanization process. At least one elastic layer may also be made of polyurethane. Polyurethane may be readily processed and sprayed onto different substrates and it can adapt itself to small unevennesses. In this manner, fabrication tolerances can be compensated for.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 shows a bushing with a core and a sleeve; and

FIG. 2 shows a bushing in which an intermediate sleeve is disposed between the core and the sleeve.

### DETAILED DESCRIPTION

The following description is merely exemplary in nature and is not intended to limit the present disclosure, application, or uses.

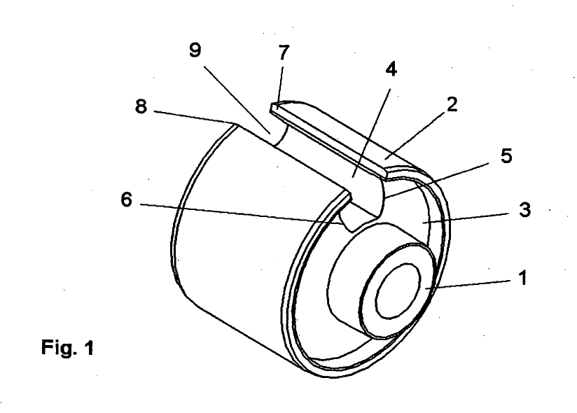

FIG. 1 shows a bushing with a core 1 that is surrounded by a sleeve 2. An elastic layer 3 is disposed between sleeve 2 and core 1. Elastic layer 3 and sleeve 2 are interrupted by a gap 4, the width of which is elastically changeable. The ends 5, 6 of elastic layer 3 on the side of the gap 4 are provided with recesses. The ends 7, 8 of sleeve 2 on the side of the gap 4 may be adapted to contact one another. Ends 5, 6 of layer 3 on the side of the gap 4 define a passage 9.

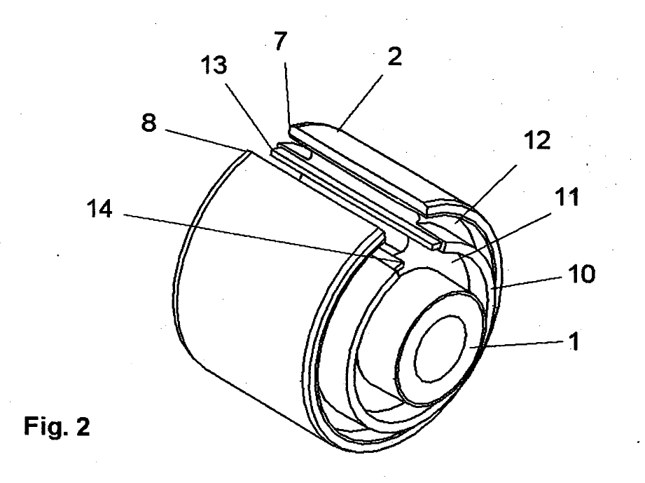

FIG. 2 shows a bushing with a core 1, a sleeve 2, and an intermediate sleeve 10. An elastic layer 11 is disposed between core 1 and intermediate sleeve 10. An elastic layer 12 is disposed between intermediate sleeve 10 and sleeve 2.

The bushings according to FIG. 1 and FIG. 2 are compressible so that a width of the gap 4 may be changed. When ends 7, 8 of sleeve 2 on the side of the gap 4 or ends 13, 14 of intermediate sleeve 10 contact each other, elastic layers 3 and 11 and 12 are subject to a defined pretension. Elastic layers 3, 11, 12 form in the region of the gap 4 hollow spaces as a result of which the radial stiffness in the direction of these hollow spaces is different from the radial stiffness perpendicular to this direction.

Finally, it should be particularly stressed that the previously entirely arbitrarily chosen practical examples serve only to discuss the teaching of the invention and do not limit it to these practical examples.

1. A bushing comprising:
a core;
at least one sleeve surrounding said cores; and
at least one elastic layer disposed between the sleeve and the core, the elastic layer and the sleeve being interrupted by a gap and the gap width being elastically changeable,
wherein ends of the elastic layer on a side of the gap are provided with recesses.

2. The bushing as defined in claim 1, wherein the ends of the at least one sleeve on the side of the gap may contact each other.

3. The bushing as defined in claim 1, wherein the ends of the at least one layer on the side of the gap define a passage.

4. The bushing as defined in claim 1, wherein the recesses of the at least one elastic layer are concave.

5. The bushing as defined in one of claim 1, wherein in at least some regions the recesses of the at least one elastic layer are spherical.

6. The bushing as defined in claim 1, wherein in the at least one elastic layer there are formed several hollow spaces separated from one another.

7. The bushing as defined in claim 1, wherein a radial stiffness along an axis of the central gap is at most 8000 N/mm.

8. The bushing as defined in claim 1, wherein a radial stiffness perpendicular to a central axis of the gap is at most 12,000 N/mm.

9. The bushing as defined in claim 1, wherein at least one intermediate sleeve is disposed between the core and the sleeve, with the at least one elastic layer being disposed between the core and the intermediate sleeve and between the intermediate sleeve and the sleeve.

10. The bushing as defined in claim 1, wherein the at least one elastic layer is connected with the sleeves and/or the core by vulcanization or pressure fitting.
